(19) United States
(12) Patent Application Publication
(10) Pub. No.: US 2014/0279440 A1
(43) Pub. Date: Sep. 18, 2014

(54) EXPORT PREPARATION AND SUPPORT SYSTEM AND METHOD

(71) Applicant: United States Postal Service, Washington, DC (US)

(72) Inventor: Shea R. Felix, Washington, DC (US)

(73) Assignee: United States Postal Service, Washington, DC (US)

(21) Appl. No.: 14/207,086

(22) Filed: Mar. 12, 2014

Related U.S. Application Data
(60) Provisional application No. 61/785,710, filed on Mar. 14, 2013.

(51) Int. Cl. G06Q 10/08

(52) U.S. Cl. CPC G06Q 10/0831; G06Q 10/08345
USPC 705/39; 705/331

(57) ABSTRACT

A system and method of generating customs documentation for the export of goods from a first country to a second country. A database populated with restrictions and/or prohibitions corresponding to thousands of goods is accessed via a computing device. A description and attributes of a good is received and an indicator for the good is determined. Prohibitions and/or restrictions corresponding to the good are presented via the device. A governmental fee for the good is determined. A database with rules to determine a form based at least on the first country, the second country, and the attributes of the good is accessed. The determined form is automatically populated with at least the indicator for the good and the governmental fee, and a label is automatically developed. The indicator and other attributes of the good, the amount of the governmental fee, and identification of the form used are stored in a database for efficient future use.

### BACKGROUND

1. Field of the Development

The development relates to a system and method for preparing goods and merchandise for export. More particularly, the development relates to an export service for use in both online and retail settings.

2. Description of the Related Art

Merchants of goods and products can have markets comprising potentially billions of international consumers or buyers in hundreds of countries. As ecommerce continues to grow, an efficient export process is essential to ensure international regulatory compliance. Small and medium businesses and other sellers that export goods and merchandise to another country desire to accurately calculate duty and applicable taxes, but generally lack the resources to pay for export preparation. A Harmonized Tariff Schedule code (HS code) can be used for the calculations. The current lax HS code requirements as applied through the postal channel can result in excessive duty and tax rates due to inadequate content descriptions captured on a CN22 or CN23 customs form, for example. In addition, merchants must adhere to various export and import regulations, including denied party screening and proper customs documentation. By not having a clear and comprehensive process for proper export and import compliance, merchants face potential fines and fees for export and import violations. Users seek peace-of-mind that products to be exported can ship without violating export and import regulations. The excessive duties, taxes, fines and fees that fall on merchants and their customers push users to seek all-inclusive tools to ensure an efficient export process.

The HS code impacts the duties, taxes, value-added taxes and fees associated with shipping cross-border. All of these costs affect the landed cost of an order. Landed cost can be defined as the product price, shipping, insurance, duties and taxes. For example, fifty-five percent of surveyed Australian consumers place high importance on understanding all additional fees that will be due at delivery while over eighty percent of Germans emphasize the same requirement (2011 International Cost and Revenue Analysis (ICRA)).

### SUMMARY

In an embodiment, there is a method of generating customs documentation for the export of goods or merchandise from a first country to a second country, the method comprising accessing, via a computing device, a database populated with restrictions and/or prohibitions corresponding to a plurality of goods or merchandise; receiving, via a computing device, a description and attributes of a good or merchandise; determining, via a computing device, a tariff code for the good or merchandise; presenting, via a computing device, prohibitions and/or restrictions corresponding to the good or merchandise; determining, via a computing device, a duty and/or tax for the good or merchandise; accessing, via a computing device, a database with rules to determine a customs form needed based at least on the first country, the second country, and the attributes of the good or merchandise; and automatically populating, via a computing device, the determined customs form with at least the tariff code for the good or merchandise and the duty and/or tax.

The method may additionally comprise storing the tariff code and other attributes of the good or merchandise, the amount of the duty and/or taxes, and identification of the form used in a database so as to facilitate faster processing of future purchases. The method may additionally comprise transmitting the stored information corresponding to the good or merchandise to a customs authority based on the first country and the second country. The method may additionally comprise automatically populating a mailing label for a package to ship the good or merchandise. Receiving a description of the good or merchandise may utilize a natural language interface. The restrictions may be unique to a carrier of the good or merchandise in the first country. The prohibitions may be specific to a carrier of the good or merchandise in the first country.

In another embodiment, there is a method of generating customs documentation for the export of goods or merchandise from a first country to a second country, the method comprising accessing, via a computing device, a database populated with restrictions and/or prohibitions corresponding to a plurality of goods or merchandise; receiving, via a computing device, attributes of a good or merchandise; determining, via a computing device, an indicator for the good or merchandise; presenting, via a computing device, prohibitions and/or restrictions corresponding to the good or merchandise; determining, via a computing device, a governmental fee for the good or merchandise; accessing, via a computing device, a database with rules to determine a form needed based at least on the first country, the second country, and the attributes of the good or merchandise; and automatically populating, via a computing device, the determined form with at least the indicator for the good or merchandise and the governmental fee. Determining an indicator for the good or merchandise may comprise accessing a database of thousands of goods or merchandise.

In another embodiment, there is a system for generating customs documentation for the export of goods or merchandise from a first country to a second country, the system comprising a first database of restrictions and/or prohibitions corresponding to a plurality of goods or merchandise; a second database with rules and forms for the export of a good or merchandise from the first country and import into the second country; a third database of thousands of goods or merchandise and corresponding codes; a computer system comprising one or more computing devices and being in data communication with the first database, the second database and the third database, the computer system programmed with executable instructions to at least receive attributes of a particular good or merchandise; determine a code for the good or merchandise via access of the third database; present prohibitions and/or restrictions from the first database corresponding to the good or merchandise; determine a governmental fee for the good or merchandise; access the second database to determine a form needed based at least on the first country, the second country, and the attributes of the good or merchandise; and populate the determined form with at least the code for the good or merchandise and the governmental fee.

The computer system may be additionally programmed with executable instructions to present a remedy if at least one of the prohibitions and/or restrictions prevents shipment of the good or merchandise. The first database, the second database and the third database may be the same database.

In another embodiment, there is a non-transitory computer storage having stored thereon a computer program that instructs a computer system to generate customs documentation for the export of goods or merchandise from a first country to a second country by at least receiving attributes of a good or merchandise; accessing a database of thousands of goods or merchandise; determining an indicator for the good or merchandise; accessing a database populated with restrictions and/or prohibitions corresponding to a plurality of goods or merchandise; presenting prohibitions and/or restrictions corresponding to the good or merchandise; determining a governmental fee for the good or merchandise; accessing a database with rules to determine a form needed based at least on the first country, the second country, and the attributes of the good or merchandise; and automatically populating the determined form with at least the indicator for the good or merchandise and the governmental fee.

In yet another embodiment, there is a system for generating customs documentation for the export of goods or merchandise from a first country to a second country, the system comprising first means for storing restrictions and/or prohibitions corresponding to a plurality of goods or merchandise; second means for storing rules and forms for the export of a good or merchandise from the first country and import into the second country; third means for storing information about thousands of goods or merchandise and corresponding codes; means for receiving attributes of a particular good or merchandise; means for determining a code for the good or merchandise via access of the third means; means for presenting prohibitions and/or restrictions from the first means corresponding to the good or merchandise; means for determining a governmental fee for the good or merchandise; means for accessing the second means to determine a form needed based at least on the first country, the second country, and the attributes of the good or merchandise; and means for populating the determined form with at least the code for the good or merchandise and the governmental fee.

### BRIEF DESCRIPTION OF THE DRAWINGS

The foregoing and other features of the disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with the additional specificity and detail through use of the accompanying drawings.

FIG. 1A is a block diagram of one embodiment of a system and method for processing an export of merchandise being transferred between two countries.

FIG. 1B is a block diagram of another embodiment of a system and method for processing an export of merchandise being transferred between two countries.

FIG. 1C is a block diagram of another embodiment of a system and method for processing an export of merchandise being transferred between two countries.

FIG. 1D is a block diagram of yet another embodiment of a system and method for processing an export of merchandise being transferred between two countries.

FIGS. 2a and 2b are a flow diagram of one embodiment of a method for processing an export of merchandise using a system such as that shown in FIGS. 1A, 1B, 1C or 1D.

FIG. 3 is a diagram illustrating two examples of a ten-digit Harmonized Tariff Schedule code for an item of merchandise.

### DETAILED DESCRIPTION OF CERTAIN EMBODIMENTS

The following detailed description of certain embodiments presents various descriptions of specific embodiments of the development. However, the development can be embodied in a multitude of different ways as defined and covered by the claims. In this description, reference is made to the drawings wherein like parts are designated with like numerals throughout.

The terminology used in the description presented herein is not intended to be interpreted in any limited or restrictive manner, simply because it is being utilized in conjunction with a detailed description of certain specific embodiments of the development. Furthermore, embodiments of the development may include several novel features, no single one of which is solely responsible for its desirable attributes or which is essential to practicing the developments herein described.

The system and method described herein can be implemented on various configurations of hardware and software. The system can be comprised of various modules, tools, and applications as discussed below. As can be appreciated by one of ordinary skill in the art, each of the modules may comprise various sub-routines, procedures, definitional statements and macros. Each of the modules are typically separately compiled and linked into a single executable program. Therefore, the following description of each of the modules is used for convenience to describe the functionality of a preferred system. Thus, the processes that are undergone by each of the modules may be arbitrarily redistributed to one of the other modules, combined together in a single module, or made available in, for example, a shareable dynamic link library. Depending on the embodiment, certain modules may be removed, merged together, or rearranged in order. Also depending on the embodiment, certain steps of the methods may be added, rearranged, combined, or removed.

The system modules, tools, and applications may be written in any programming language such as, for example, C, C++, C#, BASIC, Visual Basic, Pascal, Ada, Java, HTML, XML, or FORTRAN, and executed on an operating system, such as variants of Windows, Macintosh, UNIX, Linux, VxWorks, or other operating system. C, C++, C#, BASIC, Visual Basic, Pascal, Ada, Java, HTML, XML and FORTRAN are industry standard programming languages for which many commercial compilers can be used to create executable code.

### Definitions

The following provides a number of useful possible definitions of terms used in describing certain embodiments of the disclosed development.

A network may refer to a network or combination of networks spanning any geographical area, such as a local area network (LAN), wide area network (WAN), regional network, national network, and/or global network. The Internet is an example of a current global computer network. Those terms may refer to hardwire networks, wireless networks, or a combination of hardwire and wireless networks. Hardwire networks may include, for example, fiber optic lines, cable lines, ISDN lines, copper lines, etc. Wireless networks may include, for example, cellular systems, personal communications service (PCS) systems, satellite communication systems, packet radio systems, and mobile broadband systems. A cellular system may use, for example, code division multiple access (CDMA), time division multiple access (TDMA), personal digital phone (PDC), Global System Mobile (GSM), or frequency division multiple access (FDMA), among others. In addition, connectivity to the network may be, for example, via remote modem, Ethernet (IEEE 802.3), Token Ring (IEEE 802.5), Fiber Distributed Datalink Interface (FDDI) or Asynchronous Transfer Mode (ATM). As used herein, the network includes network variations such as the public Internet, a private network within the Internet, a secure network within the Internet, a private network, a public network, a value-added network, an intranet, and the like.

A website may refer to one or more interrelated web page files and other files and programs on one or more web servers. The files and programs are accessible over a computer network, such as the Internet, by sending a hypertext transfer protocol (HTTP or HTTPS [S-HTTP]) request specifying a uniform resource locator (URL) that identifies the location of one of the web page files, where the files and programs are owned, managed or authorized by a single business entity. Such files and programs can include, for example, hypertext markup language (HTML) files, common gateway interface (CGI) files, and Java applications. The web page files preferably include a home page file that corresponds to a home page of the website. The home page can serve as a gateway or access point to the remaining files and programs contained within the website. In one embodiment, all of the files and programs are located under, and accessible within, the same network domain as the home page file. Alternatively, the files and programs can be located and accessible through several different network domains.

A web page or electronic page may include that which is presented by a standard web browser in response to an HTTP request specifying the URL by which the web page file is identified. A web page can include, for example, text, images, sound, video, and animation.

A computer or computing device may be any processor controlled device. The computer or computing device may be a device that permits access to the Internet, including terminal devices, such as personal computers, workstations, servers, clients, mini-computers, main-frame computers, laptop computers, a network of individual computers, mobile computers, palm-top computers, hand-held computers, set top boxes for a television, other types of web-enabled televisions, interactive kiosks, personal digital assistants (PDAs), interactive or web-enabled wireless communications devices, mobile web browsers such as operating on a smartphone, or a combination thereof. The computers may further possess one or more input devices such as a keyboard, mouse, touch pad, joystick, pen-input-pad, and the like. The computers may also possess an output device, such as a visual display and an audio output. One or more of these computing devices may form a computing environment.

These computers may be uni-processor or multi-processor machines. Additionally, these computers may include an addressable storage medium or computer accessible medium, such as random access memory (RAM), an electronically erasable programmable read-only memory (EEPROM), programmable read-only memory (PROM), erasable programmable read-only memory (EPROM), hard disks, floppy disks, laser disk players, digital video devices, compact disks, video tapes, audio tapes, magnetic recording tracks, electronic networks, and other techniques to transmit or store electronic content such as, by way of example, programs and data. In one embodiment, the computers are equipped with a network communication device such as a network interface card, a modem, or other network connection device suitable for connecting to the communication network. Furthermore, the computers execute an appropriate operating system such as Linux, UNIX, any of the versions of Microsoft Windows, Apple MacOS, IBM OS/2 or other operating system. The appropriate operating system may include a communications protocol implementation that handles all incoming and outgoing message traffic passed over the network. In other embodiments, while the operating system may differ depending on the type of computer, the operating system will continue to provide the appropriate communications protocols to establish communication links with the network.

The computers may contain program logic, or other substrate configuration representing data and instructions, which cause the computer to operate in a specific and predefined manner, as described herein. In one embodiment, the program logic may be implemented as one or more object frameworks or modules. These modules may be configured to reside on the addressable storage medium and configured to execute on one or more processors. The modules include, but are not limited to, software or hardware components that perform certain tasks. Thus, a module may include, by way of example, components, such as, software components, object-oriented software components, class components and task components, processes, functions, attributes, procedures, subroutines, segments of program code, drivers, firmware, microcode, circuitry, data, databases, data structures, tables, arrays, and variables.

The various components of the system may communicate with each other and other components comprising the respective computers through mechanisms such as, by way of example, interprocess communication, remote procedure call, distributed object interfaces, and other various program interfaces. Furthermore, the functionality provided for in the components, modules, and databases may be combined into fewer components, modules, or databases or further separated into additional components, modules, or databases. Additionally, the components, modules, and databases may be implemented to execute on one or more computers. In another embodiment, some of the components, modules, and databases may be implemented to execute on one or more computers external to a website. In one instance, the website includes program logic, which enables the website to communicate with the externally implemented components, modules, and databases to perform the functions such as disclosed herein.

### Example Computing Environments

Certain embodiments of a system utilize a network as described in conjunction with FIG. 1A, or utilize a cloud, as described in conjunction with FIG. 1B. Certain embodiments are based on an example open system integrated architecture such as shown in FIG. 1A and FIG. 1B. In FIGS. 1A and 1B, the example open system integrated architecture may be based on, for example, a user interface interacting with a local or remote data repository and a local or remote application running on a local or remote application server, such as an application server 150. FIGS. 1A and 1B are block diagrams of an example system 100 that may be used to implement certain systems and methods described herein. The functionality provided for in the components and modules of computing system 100 may be combined into fewer components and modules or further separated into additional components and modules. Various other types of electronic devices communicating in a networked environment may also be used.

Referring to FIG. 1A, an example configuration of components of an embodiment of the system 100 will now be described. A mobile or fixed computing device 110 is operated by a user 130. There may be other mobile or fixed computing devices such as a device 165 operated by other users 130′. The computing device 110 can be a handheld computing device or other portable computing device such as a Palm, Pocket personal computer (PC), Linux based handheld, PDA, smartphone such as an iPhone® or Android™ based phone, a tablet computer such as an iPad® or Android based tablet, or a PC having a display. In other embodiments, the computing device can be any form of a network or Internet connected device, including but not limited to PCs, mobile devices, PDA, laptops, tablets, chips, keyboards, voice audio and video software, mouse, keypads, touch pads, track ball, microphones, videos, storage devices, network devices, databases, scanners, copiers, digital pens, image recognition software and device, screens and other forms of displays, netbooks and other forms of computer hardware. The computing device 110 in certain embodiments can operate in a stand-alone (independent) manner. In other embodiments, the computing device 110 is in communication with one or more servers 150 via a network 140, such as a local area network, a wide area network, or the Internet. The server(s) can include one or processors 152, memory 158, data storage 154 and system software 156 executed by the processor(s), and input or output devices 160. In certain embodiments, the data storage 154 stores one or more databases used by the system. The processor(s) 152 are in communication with the database(s) via a database interface, such as structured query language (SQL) or open database connectivity (ODBC). In certain embodiments, the data storage 154 is not included in server(s) 150, but is in data communication with the server(s) via the database interface. The connection from the computing device 110 to the network 140 can be a wireless or a satellite connection 144 or a wired or direct connection 142. In certain embodiments, the server(s) are part of a web site, such as a site on an intranet or the Internet.

When the computing device 110 is connected with the server(s) 150, the web site may optionally provide updates on new features. In another embodiment, the computing device runs software for the system and method described herein only when connected to the server(s) 150.

The computing device 110 can include a processor 112, memory 122, a display 114, and one or more input devices 116. The processor 112 can be in data communication with a data storage 118. In certain embodiments, the data storage 118 may store prior records of the user and/or other data or software. System software 120 can be executed by the processor 112. The system software 120 may include an application graphical user interface (GUI). The application GUI can include a database interface to the data storage 118 of the computing device. In certain embodiments, the software is loaded from the data storage 118. In embodiments where the computing device 110 communicates with a web site, the processor utilizes browser software in place of or in addition to the software 120. The network browser may be, for example, Microsoft Internet Explorer®, Apple Safari®, Mozilla Firefox®, Google Chrome™, browsers from Opera Software™, and so forth. An output device 129, such as a printer is connected to the computing device 110.

Referring to FIG. 1B, an example configuration of components of an embodiment of a system 100′ using a cloud computing architecture will now be described. The configuration of components in FIG. 1B is similar to that of FIG. 1A except that the network 140 and servers 150 of FIG. 1A are replace by the cloud 170 of FIG. 1B. An optional private cloud 172 can also be utilized. Cloud computing can include web-based tools or applications that users can access and use through a web browser as if it were a program installed locally on their own computer. In certain embodiments, the cloud 170 can comprise various computers, servers and data storage devices that function to provide a cloud platform (e.g., a web front end), cloud service (e.g., a queue), cloud infrastructure, and cloud storage (e.g., a database). A public/external cloud can be used with a private cloud in a hybrid cloud or a combined cloud environment in certain embodiments.

Referring to FIG. 1C, an example configuration of components of an embodiment of a system 100″ using a network or a cloud computing architecture will now be described. The components in FIG. 1C are similar to that of FIGS. 1A and 1B. The user or buyer of merchandise 130 experiences a similar performance of a carrier export application or program whether the application is performed through a network or the cloud. Alternatively, the user 130 can contact a call center 175 for the merchant where a call center agent fields the call and opens an export web application or program. The export application or program can be performed at a carrier website 182 or at a merchant website 186 where an application programming interface (API) can integrate the export application with the merchant website. The carrier website 182 and the merchant website 186 are in communication with a network, web and/or cloud 180 via predefined protocols. One or more database servers 190 are also in data communication with the network or cloud 180. In certain embodiments, the merchant is located in the U.S. and the buyer in a foreign jurisdiction. In other embodiments, the merchant can be in a non-U.S. jurisdiction and the buyer can be in the U.S., or in yet other embodiments, both can be can be in different non-U.S. jurisdictions. A foreign carrier website (not shown) can be in communication with the network or cloud 180 to implement the export application for the scenario where merchandise is being exported to the U.S., or for the scenario where the merchandise is exported from one foreign country to a buyer in another foreign country.

The carrier website 182 can be in data communication with one or more databases 184. The databases 184 can include, but are not limited to, service type and rate information, tariff codes corresponding to merchandise, buyer information (e.g., address), postage due facility information, tracking information, billing information, customs information and locations and merchant information, such as merchant name and type, merchant return location(s), account ID, service preferences, customer registration ID, mailer ID, permit number, and so forth.

The merchant website 186 can be in data communication with one or more databases 188. The databases 188 can include, but are not limited to, merchandise/product information, service type and rate information, tariff codes, buyer information (e.g., address), postage due facility information, customs information and locations, and so forth. In certain embodiments, other merchants (not shown) can communicate with the network or cloud 180.

The database server(s) 190 can be in data communication with one or more databases 192. The database servers, in some embodiments can include the Census Bureau's Automated Export System (AES) and the Commerce Department's Bureau of Industry and Security (BIS) for determining the Export Control Classification Number (ECCN). The database servers could also include a third-party association of postal operators or carriers website. The databases 192 can include, but are not limited to, service type and rate information, tariff codes, buyer information (e.g., address), merchant information, tracking information, customs information and locations, Census Bureau information, Commerce Department information, third-party shared information, and so forth. In certain embodiments, other foreign carriers (not shown) can communicate with the network or cloud 180.

Referring to FIG. 1D, an example configuration of components of an embodiment of a system 100′″ using a network or a cloud computing architecture will now be described. The components in FIG. 1D are similar to that of FIG. 1C. However, in this embodiment, the merchant can utilize a facility or device 196 such as a retail point of sale (POS), an automated postal center, such as an automated carrier center kiosk, or other device or facility for performing the export process and preparing the merchandise for shipment.

### Operation

A carrier or agent of merchandise or goods is faced with an unprecedented need to collect accurate customs data electronically and to screen for denied party recipients prior to acceptance of a shipment according to regulations set forth by the Bureau of Industry and Security. In addition, regulations set forth by the European Commission now require a carrier to include a harmonized tariff code on goods entering the European Union valued at twenty euros or more. Consumers or buyers of merchandise ordered online (or via telephone or mail) want to know costs of taxes, duties and whether the merchandise can be exported to the country of the consumer. Certain embodiments described below explain an easy to perform export process, e.g., without going to a carrier office. In other embodiments, a merchant can use an automated carrier center kiosk or other carrier facility for an improved customer experience due to a more consistent customs clearance process. The carrier and the merchant benefit by limiting international delivery refusals and unpaid ‘return to sender’ shipments due to unexpected duty and tax assessments. The consumer benefits by having visibility into import taxes and fees, knowing if a product can be imported, increasing in confidence in purchasing cross-border and in the customs clearance process.

The system and method described herein are applicable for use with two or more different countries, where a purchaser or consumer located in one country orders merchandise from a merchant of the merchandise located in another country. In other embodiments, the merchandise may be purchased from an entity that is not a merchant, such as a private party, for example. For the example processes described herein, the merchant is described as being in the United States, although the process is also applicable if the merchant is in another country.

Referring to FIGS. 2a and 2b, an example international merchandise export module or process 200 will be described. In module or process 200, when a user places an order for merchandise that needs to cross an international border to be delivered, various ones of the following actions are performed: various shipping/delivery charges are estimated, one or more tariff schedule codes are determined, a landed cost is calculated, restrictions on exports and imports are determined and checked, denied parties are checked, —required documents are prepared, captured data is stored and optionally forwarded to one or more carriers and/or government agencies, and so forth. Computer implemented steps of the module or process may be performed on the system 100 shown in FIG. 1A, system 100′ shown in FIG. 1B, system 100″ shown in FIG. 1C, or system 100′″ shown in FIG. 1D. Depending on the embodiment, certain steps of the module or process may be added, rearranged, combined into submodules, or removed.

Beginning at a start state 202, process 200 continues at state 204 where a user, buyer or consumer in a first country purchases merchandise from a merchant via the Internet, world wide web, or other online means, although the purchase can be performed via the telephone, mail, or other means. In certain embodiments, the merchant or seller is located in the United States, while in other embodiments, the merchant or seller is in a country other than the United States. For the sake of brevity, the remainder of the description of example module or process 200 will discuss a U.S. merchant, although the description can apply to a non-U.S. merchant or seller.

Continuing at state 206, package level details are collected electronically. The merchant or a service for the merchant calculates or obtains calculated shipping charges and optional fees, such as insurance, of a carrier or agent, such as the United States Postal Service (USPS®). This calculation can be performed using a program or application on a website for the carrier. For example, the program or application can be part of an export application or program performed at a U.S. carrier website 182 or alternatively at a merchant website 186 where an application programming interface (API) or plug-in can integrate the export application with a shipping application at the merchant website. The export application can also be available online through an interface accessible through a postal shipping application, such as Click-N-Ship® (CNS), Click-N-Ship for Business® (CNSB) or Global Shipping Software (GSS) available from the USPS. In other embodiments, the merchant may bring the merchandise or good(s) to a retail POS or automated carrier center so that state 206 is performed along with subsequent states up to state 258, for example. Future embodiments include mobile applications, like the USPS iPhone, Android or other platform application, and major marketplaces such as eBay or Amazon so that both non-commercial and commercial shippers are in export compliance.

Proceeding to state 208, process 200 classifies products and determines a harmonized tariff schedule (HS) code for the ordered merchandise based on a product description and country of import that are collected electronically. The HS code can universally identify a product for customs agents. The harmonized tariff schedule is maintained by the World Customs Organization. The first six digits describe products across all participating countries. A final four to eight digits narrow a product's description and are country specific. See FIG. 3 for a first classification example 310 of a boy's cotton t-shirt exported to Canada, and a second example 320 of a boy's cotton t-shirt exported to Australia. Most countries, including the U.S., the European Union, Australia and Japan use HS codes to accurately classify imports. To identify an HS code, a merchant provides a product description to module 200 which narrows the potential field of applicable HS codes. Module 200 guides merchants through a selection and refinement process, including identifying the country of origin and the country of import, to identify the most relevant HS code. Module 200 then captures the appropriate HS code in the designated field on the carrier customs form. In some embodiments, module 200 notifies the merchant of changes in HS code classification. In some embodiments, a natural language lookup capability is utilized for recognizing the product and mapping it to a code. Alternatively, other easy-to-use mechanisms can be used to identify the product and obtain a code.

In certain embodiments, module 200 can store product harmonization and country of origin results and create a nickname for product entry. When product codes are updated, module 200 can update and/or alert the stored list. The harmonized data collected can be fed through a Pre-Advise channel to US Customs.

Advancing to state 210, module 200 uses the HS code and collected merchandise information or attributes, and estimates accurate import duties, excise and value added taxes, customs fees and other export or import levies by country. In certain embodiments, state 210 determines a most-favored nation status between the U.S. and the country of import. The estimated duties and taxes can be based on the HS code selection, country of origin and most-favored nation status. Module 200 can provide a mechanism to notify the end-customer or buyer the estimates for the duty and tax. Module 200 can also notify the merchant of changes in duty and tax rates.

Proceeding to state 212, when the duty and tax is combined with the order value, shipping and insurance and other fees and levies, the consumer and the merchant alike are made aware of an order's landed cost. The landed cost allows merchants to determine the true value of a product and helps prevent consumers from paying unexpected fees as a result of shopping cross-border.

Continuing at state 214, module 200 checks for export restrictions on the ordered merchandise, including monitoring export regulations around the world to ensure shipments are lawful. As an example, it is currently illegal to ship lithium batteries internationally through the postal channel. Module 200 utilizes the HS code to identify whether the item contains a lithium battery and notifies the customer of the carrier regulation violation. Module 200 can utilize a series of questions to determine carrier shipping eligibility, including commercial export eligibility, such as “is the item a liquid, perishable, fragile or dangerous?” For example alcohol, perfume, nail polish, flea collars or sprays, aerosols, bleach, pool chemicals, paints, matches, batteries, fuels or gasoline, airbags, dry ice, mercury thermometers, cleaning supplies, items previously containing fuel, glue, and fireworks cannot be presently shipped internationally. Prescription medicines can only be mailed by registered practitioners or dispensers. Only licensed manufacturers can mail handguns. In certain embodiments, applicable data is stored in a merchant's product database for future access.

Moving to a decision state 216, module 200 determines if export restrictions are violated. If so, process 200 advances to a decision state 218 to determine if the merchandise can be exported based on the export regulations. If the merchandise cannot be exported, module 200 notifies the user at state 220 that the merchandise cannot be exported and a reason why the merchandise cannot be exported. Module 200 then completes at an end state 222. However, if the export restrictions are not violated, as determined at decision state 216 or the merchandise can be exported, as determined at decision state 218, module 200 advances to state 230.

At state 230, module 200 determines if an export control classification number (ECCN), an automated export system filing, an export license or other export requirement is needed and identifies a remedy, if needed. For example, if the value of a product identified by a single HS code exceeds $2,500 (each item is valued at $250 and there are ten in one shipment), a Census Bureau's Automated Export System filing is required. Module 200 identifies this requirement, provides guidance on how and where to file and log the violation to ensure all parties are aware. Module 200 also determines a proper ECCN number.

Proceeding to state 232, module 200 checks for import restrictions of the destination country on the ordered merchandise, including monitoring import regulations around the world to ensure shipments are lawful. Module 200 can determine the eligibility for importing specific products into the destination country through the postal channel, including determining commercial eligibility for importing products into the destination country.

Moving to a decision state 234, module 200 determines if import restrictions are violated. If so, process 200 advances to a decision state 236 to determine if the merchandise can be imported based on import regulations. If the merchandise cannot be imported, module 200 notifies the user at state 238 that the merchandise cannot be imported and a reason why the merchandise cannot be imported. Module 200 then completes at the end state 222. However, if the import restrictions are not violated, as determined at decision state 234 or the merchandise can be imported, as determined at decision state 236, module 200 advances to a decision state 244.

At decision state 244, module 200 determines if the exporter and/or the recipient of the merchandise are on the denied party lists of U.S. and foreign governments and agencies. The denied party screening identifies the legitimacy of both the sender and the importer. Applicable lists are scanned, such as lists compiled by the export and import countries including the U.S. State department, U.S. Customs and Border Protection CBP), U.S. Treasury's Office of Foreign Assets Control (OFAC), U.S. Commerce Department's Bureau of Industry and Security (BIS), European Commission, the United nations, and other foreign government agencies to identify and restrict shipments to blacklisted entities and individuals. The denied parties can be screened by address, country, entity or individual in certain embodiments. OFAC and BIS maintain regulations that block assets, products and services from being sent to persons, entities or countries determined to be adverse to U.S. interests. These agencies implement sanctions imposed by Congress, the president and the United Nations. CBP, OFAC and BIS enforce these export controls and their jurisdiction applies to all governmental entities as well as private parties. A carrier is subject to significant financial risk if any international mail is exported that violates export regulations. BIS can impose civil penalties, plus criminal penalties, jail time for individual violators, and administrative penalties such as seizure of property and denial of export privileges. These penalties make the need for proper product classification and export documentation important. If the exporter and/or recipient are on the denied party lists, module 200 notifies the user that the merchandise cannot be exported at state 246, and completes at end state 222.

If the exporter and/or recipient are not on the denied party lists, as determined at decision state 244, module 200 proceeds to state 250. At state 250, module 200 determines necessary forms required of the country of export and the country of import. The required export and import forms are identified, including certificates of origin, packing slips, ECCN documentation, commercial invoice, and others where applicable. In certain embodiments, module 200 produces the forms, and at the same time, pre-populates the forms with the necessary information based on the collected data. In some embodiments, module 200 also produces a shipping label. In certain embodiments, the shipping label can be combined with a customs form. The information identified in the previous states can ensure that data elements and accurate product descriptions are reflected on all documents. Proper documentation increases customs efficiency for the export country and import country which expedites the shipping process.

Moving to state 252 of FIG. 2b, module 200 optionally provides the user with an option for prepayment of duty, tax and other fees in certain embodiments. In certain embodiments, the merchant obtains advance payment from the buyer before prepaying the duty, tax and other fees. The prepayment eliminates the need to pay the duty and/or tax and fees at the time of delivery, which speeds up the delivery and makes the export process more efficient. The prepayment also reduces the possibility that the buyer would refuse delivery of the package and not pay, leading to possible losses for both the domestic and foreign carriers.

Advancing to state 254, in certain embodiments, one or more completed forms, and optionally a shipping label, are printed for use by the user with the corresponding international shipment. The forms and label can be attached to the package in various ways, such as directly to the package or in a clear pouch that is attached to the package, to facilitate delivery of the package via the carrier to customs, a tax authority, and so forth.

Continuing at state 256, module 200 stores the data from the transaction in a merchant database and/or in a carrier database. In certain embodiments, each merchant using the export application has an associated database. For each product processed via module 200, information about the product and corresponding to the product is stored in the database for the appropriate merchant. This information can include the tariff code, attributes of the merchandise, the amount of the duty and/or taxes and identification of the customs forms used. In some embodiments, the carrier can maintain one or more databases with tables for each merchant using the export application. In certain embodiments, the stored information can be used to ease repeat use, increase customer affinity and facilitate faster processing of future purchases that are similar to the current merchandise.

Proceeding to state 258, at least portions of the data from the export transaction can be electronically sent to a customs agency, such as the U.S. Customs and Border Protection. In certain embodiments, this data can be used in expediting the shipment when it is received at the agency.

There are generally two potential outcomes for merchants using module 200: a properly prepared export, or an export with one or more regulatory exceptions. In the first outcome, a properly prepared export contains all the documentation necessary for smooth export of the item to another country. The package is then ready to be inducted through a post office, carrier pickup or dropped at a bulk mail acceptance unit depending on merchant preference or contractual agreement, as shown at state 260. In the second scenario, the module 200 waits to generate the labels and forms while identifying the exception and offering remedies, where applicable. For example, if the product requires an automated export system (AES) filing, module 200 can redirect the merchant to the AES website and save the merchant's progress, while highlighting the missing field on the customs form. After the merchant concludes their AES filing and enters the AES number on the customs form, the exception is lifted and label and form generation can proceed. If the shipment is unable to be shipped abroad, the merchant is denied the ability to generate a customs form effectively blocking that shipment.

Proceeding to state 262, the package of the merchandise and the customs documentation are shipped to the customs agency, such as the U.S. Customs and Border Protection, by the carrier for customs processing of the package. At state 264, if the customs documentation is complete and in order, the package is forwarded to a customs agency for the foreign country being shipped to. The foreign customs agency officially assesses the duty and/or tax for the merchandise being shipped to the buyer or recipient. The amount of the duty and/or tax can be the same as was originally estimated at state 222, or may differ, such as for example, if new rules were just instituted by the foreign country. The package is then delivered by a foreign carrier to the buyer or recipient at state 268, and the duty and/or tax assessed by the foreign customs agency is collected by the foreign carrier via a payment on delivery method, such as cash on delivery. However, if the duty and/or taxes and other fees were previously prepaid, such as at state 252, the foreign carrier does not need to collect the payment at the time of delivery. Module 200 then completes at end state 222.

In other embodiments, the first country where the consumer is located can be the United States, and the country where the merchant is located is another country, such as Canada. In such a scenario, a carrier or agent, such as Canada Post, ships the package from the Canadian merchant to the Canada Border Services Agency, which then provides the package to a carrier or agent, such as the USPS, for delivery to the U.S. consumer or buyer. The process can be utilized with other countries as well.

Various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, e.g., one or more modules of computer program instructions, encoded on a computer storage media for execution by, or to control the operation of, data processing apparatus.

If implemented in software, the functions may be stored on or transmitted over as one or more instructions or code on a computer-readable storage medium. The steps of a method or algorithm disclosed herein may be implemented in a processor-executable software module which may reside on a computer-readable storage medium. Computer-readable storage media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above can also be included within the scope of computer-readable storage media. Additionally, the operations of a method or algorithm may reside as one or any combination or set of codes and instructions on a machine readable storage medium and computer-readable storage medium, which may be incorporated into a computer program product.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Instructions refer to computer-implemented steps for processing information in the system. Instructions can be implemented in software, firmware or hardware and include any type of programmed step undertaken by components of the system.

As can be appreciated by one of ordinary skill in the art, each of the modules of the invention may comprise various sub-routines, procedures, definitional statements, and macros. Each of the modules are typically separately compiled and linked into a single executable program. Therefore, the description of each of the modules is used for convenience to describe the functionality of the system. Thus, the processes that are undergone by each of the modules may be arbitrarily redistributed to one of the other modules, combined together in a single module, or made available in a shareable dynamic link library. Further each of the modules could be implemented in hardware.

### CONCLUSION

The foregoing description details certain embodiments. It will be appreciated, however, that no matter how detailed the foregoing appears in text, the development may be practiced in many ways. It should be noted that the use of particular terminology when describing certain features or aspects of the development should not be taken to imply that the terminology is being re-defined herein to be restricted to including any specific characteristics of the features or aspects of the development with which that terminology is associated.

While the above detailed description has shown, described, and pointed out novel features of the development as applied to various embodiments, it will be understood that various omissions, substitutions, and changes in the form and details of the device or process illustrated may be made by those skilled in the technology without departing from the intent of the development. The scope of the development is indicated by the appended claims rather than by the foregoing description. All changes which come within the meaning and range of equivalency of the claims are to be embraced within their scope.

1. A method of generating customs documentation for the export of goods or merchandise from a first country to a second country, the method comprising:
accessing, via a computing device, a database populated with restrictions and/or prohibitions corresponding to a plurality of goods or merchandise;
receiving, via a computing device, a description and attributes of a good or merchandise;
determining, via a computing device, a tariff code for the good or merchandise;
presenting, via a computing device, prohibitions and/or restrictions corresponding to the good or merchandise;
determining, via a computing device, a duty and/or tax for the good or merchandise;
accessing, via a computing device, a database with rules to determine a customs form needed based at least on the first country, the second country, and the attributes of the good or merchandise; and
automatically populating, via a computing device, the determined customs form with at least the tariff code for the good or merchandise and the duty and/or tax.

2. The method of claim 1, additionally comprising storing the tariff code and other attributes of the good or merchandise, the amount of the duty and/or taxes, and identification of the form used in a database so as to facilitate faster processing of future purchases.

3. The method of claim 2, additionally comprising transmitting the stored information corresponding to the good or merchandise to a customs authority based on the first country and the second country.

4. The method of claim 1, additionally comprising automatically populating a mailing label for a package to ship the good or merchandise.

5. The method of claim 1, wherein receiving a description of the good or merchandise utilizes a natural language interface.

6. The method of claim 1, wherein the restrictions are unique to a carrier of the good or merchandise in the first country.

7. The method of claim 1, wherein the prohibitions are specific to a carrier of the good or merchandise in the first country.

8. A method of generating customs documentation for the export of goods or merchandise from a first country to a second country, the method comprising:
accessing, via a computing device, a database populated with restrictions and/or prohibitions corresponding to a plurality of goods or merchandise;
receiving, via a computing device, attributes of a good or merchandise;
determining, via a computing device, an indicator for the good or merchandise;
presenting, via a computing device, prohibitions and/or restrictions corresponding to the good or merchandise;
determining, via a computing device, a governmental fee for the good or merchandise;
accessing, via a computing device, a database with rules to determine a form needed based at least on the first country, the second country, and the attributes of the good or merchandise; and
automatically populating, via a computing device, the determined form with at least the indicator for the good or merchandise and the governmental fee.

9. The method of claim 8, wherein determining an indicator for the good or merchandise comprises accessing a database of thousands of goods or merchandise.

10. A system for generating customs documentation for the export of goods or merchandise from a first country to a second country, the system comprising:
a first database of restrictions and/or prohibitions corresponding to a plurality of goods or merchandise;
a second database with rules and forms for the export of a good or merchandise from the first country and import into the second country;
a third database of thousands of goods or merchandise and corresponding codes;
a computer system comprising one or more computing devices and being in data communication with the first database, the second database and the third database, the computer system programmed with executable instructions to at least:
receive attributes of a particular good or merchandise;
determine a code for the good or merchandise via access of the third database;
present prohibitions and/or restrictions from the first database corresponding to the good or merchandise;
determine a governmental fee for the good or merchandise;
access the second database to determine a form needed based at least on the first country, the second country, and the attributes of the good or merchandise; and
populate the determined form with at least the code for the good or merchandise and the governmental fee.

11. The system of claim 10, wherein the computer system is additionally programmed with executable instructions to present a remedy if at least one of the prohibitions and/or restrictions prevents shipment of the good or merchandise.

12. The system of claim 10, wherein the first database, the second database and the third database are the same database.

13. A non-transitory computer storage having stored thereon a computer program that instructs a computer system to generate customs documentation for the export of goods or merchandise from a first country to a second country by at least:
receiving attributes of a good or merchandise;
accessing a database of thousands of goods or merchandise;
determining an indicator for the good or merchandise;
accessing a database populated with restrictions and/or prohibitions corresponding to a plurality of goods or merchandise;
presenting prohibitions and/or restrictions corresponding to the good or merchandise;
determining a governmental fee for the good or merchandise;
accessing a database with rules to determine a form needed based at least on the first country, the second country, and the attributes of the good or merchandise; and
automatically populating the determined form with at least the indicator for the good or merchandise and the governmental fee.

14. A system for generating customs documentation for the export of goods or merchandise from a first country to a second country, the system comprising:
first means for storing restrictions and/or prohibitions corresponding to a plurality of goods or merchandise;
second means for storing rules and forms for the export of a good or merchandise from the first country and import into the second country;
third means for storing information about thousands of goods or merchandise and corresponding codes;
means for receiving attributes of a particular good or merchandise;
means for determining a code for the good or merchandise via access of the third means;
means for presenting prohibitions and/or restrictions from the first means corresponding to the good or merchandise;
means for determining a governmental fee for the good or merchandise;
means for accessing the second means to determine a form needed based at least on the first country, the second country, and the attributes of the good or merchandise; and
means for populating the determined form with at least the code for the good or merchandise and the governmental fee.

15. The method of claim 1, wherein the duty and/or tax is for the export of the good or merchandise from the first country to the second country.

16. The method of claim 8, wherein the governmental fee is for the export of the good or merchandise from the first country to the second country.

17. The system of claim 10, wherein the governmental fee is for the export of the good or merchandise from the first country to the second country.

18. The non-transitory computer storage of claim 13, wherein the governmental fee is for the export of the good or merchandise from the first country to the second country.

19. The system of claim 14, wherein the governmental fee is for the export of the good or merchandise from the first country to the second country.

20. The method of claim 1, additionally comprising receiving a prepayment of the duty and/or tax at the time of automatically populating the determined customs form.

21. The method of claim 1, additionally comprising determining a handling fee for at least a carrier of the good or merchandise in the second country.

22. The method of claim 21, additionally comprising receiving prepayment of the duty and/or tax and/or handling fee before shipment of the good or merchandise.

23. The method of claim 8, additionally comprising determining a handling fee for at least a carrier of the good or merchandise in the second country.

24. The method of claim 23, additionally comprising receiving prepayment of the governmental fee and/or handling fee before shipment of the good or merchandise.
